(19) United States
(12) Patent Application Publication
(10) Pub. No.: US 2014/0118459 A1
(43) Pub. Date: May 1, 2014

(54) IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Kazumasa Takada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/064,419

(22) Filed: Oct. 28, 2013

(30) Foreign Application Priority Data
Nov. 1, 2012 (JP) 2012-242157

(51) Int. Cl. B41J 2/47

(52) U.S. Cl. CPC B41J 2/47
USPC 347/247

(57) ABSTRACT

An image forming apparatus according to the embodiment includes a plurality of print heads and a processor. Each of the print heads includes a plurality of light emitting devices and a storing unit configured to store light amount correction data of each of the light emitting devices. The processor acquires each of the light amount correction data stored in the storing units of the print heads, verifies whether each of the acquired light amount correction data is regular data, and, if the light amount correction data is regular data, outputs the regular data to the print head at an acquisition source and, if the light amount correction data is irregular data, acquires the light amount correction data from the print head at the acquisition source of the irregular data again and performs the verification concerning the light amount correction data.

### CROSS-REFERENCE TO RELATED APPLICATION

This application is based upon and claims the benefit of priority from Japanese Patent Application No. 2012-242157, filed Nov. 1, 2012, the entire contents of which are incorporated herein by reference.

### FIELD

Embodiments described herein relate generally to an image forming apparatus mounted with a print head configured by arranging a plurality of light emitting devices such as LEDs (Light Emitting Diodes) or organic EL (Electro Luminescence) devices.

### BACKGROUND

A print head configured by arranging a plurality of light emitting devices such as LEDs or organic EL devices is a line head. In an image forming apparatus capable of printing A3 sheets, light emitting devices equivalent to the A3 or larger size are present. For example, in an A3 600 dpi (dots per inch) head, 7016 or more light emitting devices are necessary.

The light emitting devices are formed by a semiconductor process integrally with a driver that drives the light emitting devices. The light emitting devices are configured in units of n (192, 256, etc.) pieces per one driver. A print head including a necessary number of light emitting devices is formed by arranging m pieces of the one driver unit. For example, if the number of light emitting devices is 256 per one driver, to form 7016 or more light emitting devices, the number of drivers m is set to 28. Consequently, a print head including 7168 light emitting devices is obtained.

In the print head having such a structure, image streaks occur if correction of light amount fluctuation and the like of the respective light emitting devices is not performed. Therefore, it is necessary to correct fluctuation among the light emitting devices in order to realize high image quality. Therefore, the print head includes a mechanism for correcting light amounts. Correction data different for each print head is stored in a nonvolatile memory. such as an EEPROM (Electrically Erasable Programmable Read Only Memory) mounted on the print head.

A value of the correction data needs to be set in the print head. A structure can be adopted in which the correction data is read out inside the print head and correction values are set inside the print head. However, it is necessary to mount a dedicated IC (Integrated Circuit) or the like inside the print head. This prevents a reduction in size and a reduction in costs.

Therefore, a mechanism for reading out the correction data and actually performing correction is included in the print head. However, in general, processing for reading out the correction data and setting the correction data in the print head is controlled by a dedicated IC on a separate substrate mounted on an image forming apparatus including the print head.

As light amount correction data, for example, an amount of data corresponding to the number of light emitting devices is read as serial data using a 1-bit data signal line. If data corruptions occur because of the influence of noise when the light amount correction data is read out from the print head by the dedicated IC on the separate substrate, the wrong data is set in the print head as the light amount correction data. Consequently, a streak image is formed and image quality is deteriorated.

Therefore, a checksum collation is performed in order to check whether data is correctly read out. If checksums do not match, a retry operation for reading data again is performed. However, even if the retry operation is performed, a checksum abnormality sometimes occurs again. In the case of a normal color image forming apparatus, since there is data for four colors of yellow, magenta, cyan, and black, the data for all the four colors needs to be normally read out within a specified time. Therefore, an upper limit number of times is set for the number of times of retry. If data is not correctly read out within a specified number of times, it is determined that there is some abnormality and processing for deciding an error is performed. If the upper limit number of times of the number of times of retry is increased in order to obtain accurate light amount correction data, deterioration in performance is caused. Further, since a communication operation time increases, consumed energy also undesirably increases. Therefore, there is a demand for devising a readout method that is as efficient as possible.

An operation in the past is an operation for reading out light amount correction data for the four colors, collating checksums, and, if a checksum error occurs in at least one of the colors, reading out the light amount correction data for all the four colors again and performing the checksum collation. It is a waste of energy to perform the retry operation for the colors without a problem. Further, if the retry operation is performed, there is a more risk that, because of the influence of a disturbance or the like, a checksum error occurs even in the colors that are normal in the preceding checksum collation.

### DESCRIPTION OF THE DRAWINGS

FIG. 1 is a schematic diagram showing a configuration example of an entire image forming apparatus in an embodiment;

FIG. 2 is an enlarged diagram of a drum and a print head;

FIG. 3 is a block diagram of a light amount correcting mechanism in the embodiment;

FIG. 4 is a flowchart for explaining an operation example of the light amount correcting mechanism; and

FIGS. 5A and 5B are diagrams for explaining an example of the number of times of retry performed when the light amount correcting mechanism is not applied and the number of times of retry performed when the light amount correcting mechanism is applied.

### DETAILED DESCRIPTION

An embodiment is devised in order to solve the problems and it is an object of the embodiment to realize reductions in power consumption and a communication error risk.

An image forming apparatus according to the embodiment includes a plurality of print heads and a processor. Each of the plurality of print heads includes a plurality of light emitting devices and a storing unit configured to store light amount correction data of each of the plurality of light emitting devices. The processor acquires each of the light amount correction data stored in the storing units of the plurality of print heads, verifies whether each of the acquired light amount correction data is regular data, and, if the light amount correction data is regular data, outputs the regular data to the print head at an acquisition source and, if the light amount correction data is irregular data, acquires the light amount correction data from the print head at the acquisition source of the irregular data again and performs the verification concerning the light amount correction data.

The image forming apparatus in this embodiment performs control for performing a retry operation for only a color for which a checksum collation error occurs. The image forming apparatus is explained below with reference to the drawings.

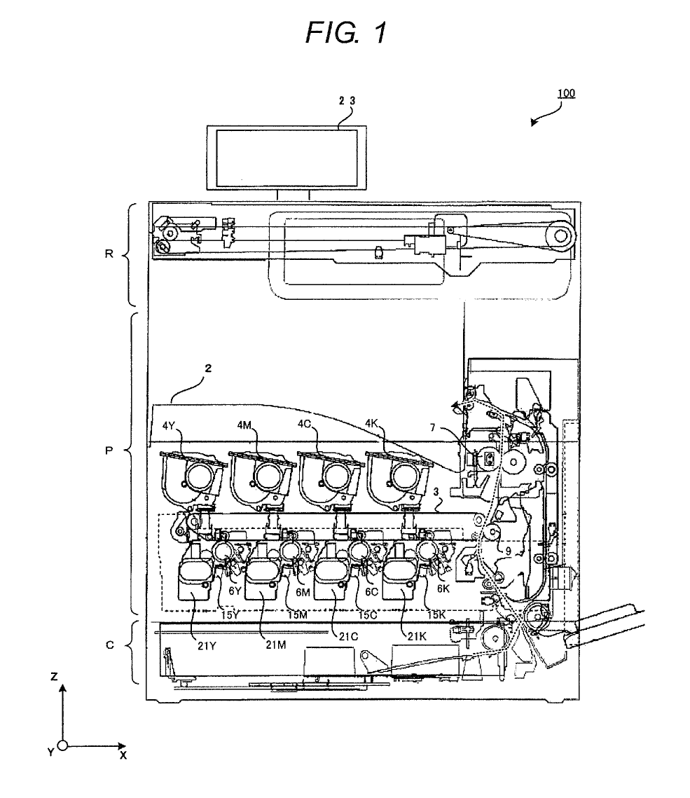

FIG. 1 is a sectional view showing an overall configuration of the image forming apparatus in this embodiment. An image forming apparatus 100 includes a scanner unit R, an image forming unit P, a sheet supplying unit C, and a control panel 23 (a notifying unit).

The scanner unit R is a unit configured to convert an image formed on a document sheet into electronic data. The scanner unit R includes at least a luminous body configured to irradiate the document sheet and a CCD image sensor (Charge Coupled Device Image Sensor) configured to convert light into an electronic signal. The scanner unit R may include a CIS (Contact Image Sensor).

The image forming unit P is a unit configured to form an image in color on a sheet from a scan image (electronic data) obtained by the scanner unit R or printing data transmitted from an external apparatus such as a computer. The image forming unit P includes process units for respective colors of yellow (Y), magenta (M), cyan (C), and black (K). The process units respectively form images on the sheet, whereby a color image is formed.

The sheet supplying unit C is a cassette configured to store new sheets or recycle sheets and supplies the sheets to the image forming unit P. The control panel 23 includes an input unit of a touch panel type configured to receive an instruction from a user and a display unit of a liquid crystal panel type configured to display processing content, progress information, a message, and the like.

A copy operation of the image forming apparatus 100 is explained. An image of a sheet read by the scanner unit R is temporarily stored in a storage device (not shown in the figure) as a scan image. A photoconductive material is applied to the surfaces (photoconductive surfaces) of drums 6Y to 6K. The photoconductive surfaces are uniformly charged by chargers and print heads 15Y to 15K irradiate the photoconductive surfaces, whereby latent images of the scan image are formed.

Toner cartridges 4Y to 4K respectively store color toners of Y, M, C, and K and supply the toners to developing devices 21Y to 21K. The developing devices 21Y to 21K deposit the supplied toners on the drums 6Y to 6K using magnet rollers to develop the latent images on the photoconductive surfaces of the drums 6Y to 6K. Developed images (toner images) formed on the drums 6Y to 6K in this way are primarily transferred onto an intermediate transfer belt 3.

On the other hand, the sheet supplied by the sheet supplying unit C is conveyed in a broken line arrow direction in FIG. 1. The toner images on the intermediate transfer belt 3 is transferred (secondarily transferred) onto the sheet by a secondary transfer roller 9. The sheet after the secondary transfer is conveyed to a fixing device 7 and heated to temperature equal to or higher than a predetermined temperature, whereby the toner images are fixed on the sheet. The sheet after the fixing is discharged to a discharge tray 2.

A print operation is the same as the operation explained above except that an acquisition source of document data is a computer.

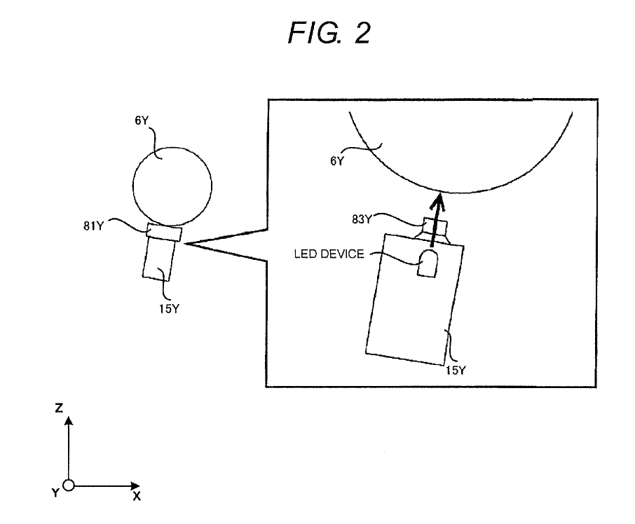

An enlarged diagram of the drum 6Y and the print head 15Y is shown in FIG. 2. The configuration of the print head 15Y is explained. The print heads 15M, 15C, and 15K have the same configuration.

The print head 15Y includes a plurality of LED devices (light emitting devices) arranged side by side in a Y-axis direction. LED light of the print head 15Y is irradiated on the drum 6Y through a lens 83Y. The LED devices respectively emit lights according to a scan image, whereby a latent image is formed on the drum 6Y. The distance between the print head 15Y and the drum 6Y is kept constant by a gap spacer 81Y.

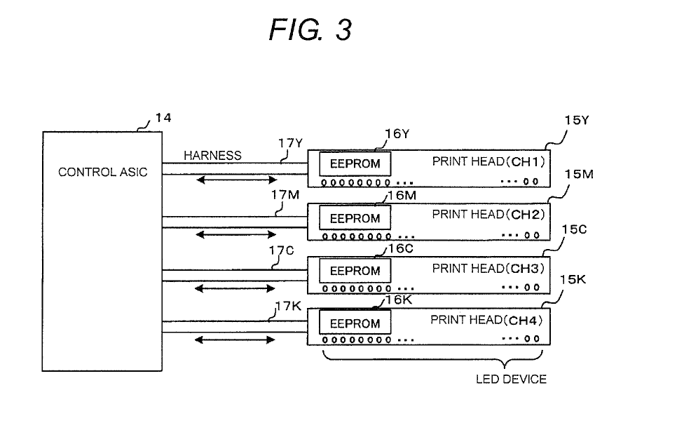

A light emission control mechanism of the print head is explained with reference to a block diagram of FIG. 3. In this embodiment, the four-color print head configuration of Y, M, C, and K is explained as an example. In the following explanation, the print head 15Y is mainly explained. However, the other print heads are the same.

The print head 15Y is mounted with an EEPROM 16Y, which is a nonvolatile memory in which light amount correction data and the like are stored. Readout of data, a checksum collation, setting of light amount correction data for the print head 15Y, and the like are performed by a control ASIC 14 (ASIC: Application Specific Integrated Circuit) mounted on a control board side. The control ASIC 14 and the print head 15Y are connected by a harness 17Y. Signals are input to and output from the control ASIC 14 and the print head 15Y via the harness 17Y. When the control ASIC 14 acquires the light amount correction data stored in the EEPROM 16Y, it is likely that data corruptions occur because of the influence of noise. Therefore, it is necessary to perform a checksum collation and detect a data defect.

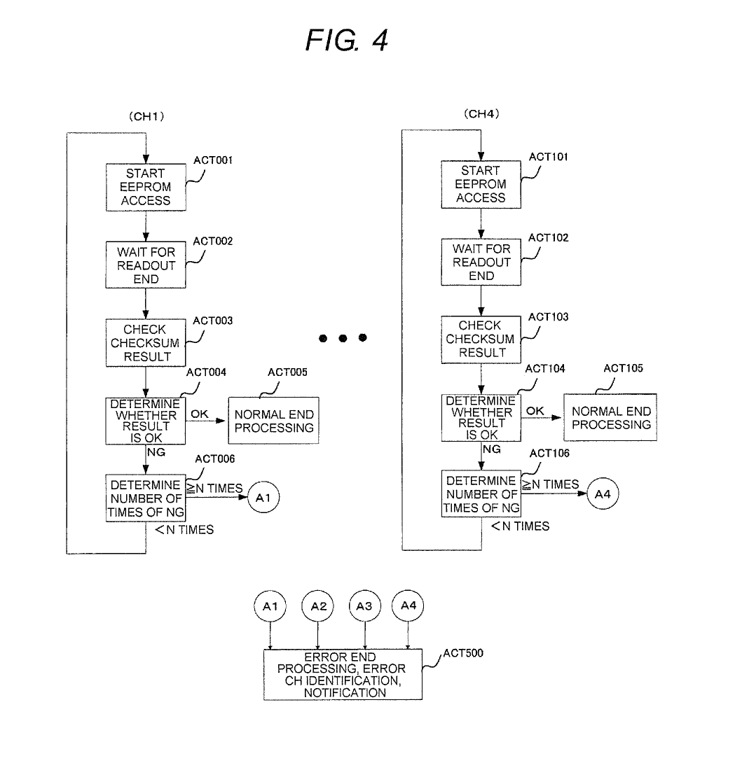

A flowchart concerning readout of light amount correction data, a checksum collation, and a retry operation in this embodiment is shown in FIG. 4. The operation shown in the flowchart is performed every time a job is issued.

First, the control ASIC 14 outputs a readout start signal for the EEPROM 16Y to the print head 15Y via the harness 17Y. Consequently, access to the EEPROM 16Y is started (ACT 001).

In ACT 002, first, the control ASIC 14 reads out and acquires a checksum value stored in the EEPROM 16Y beforehand. Subsequently, the control ASIC 14 reads out and acquires light correction data of the LED devices from the EEPROM 16Y via the harness 17Y at any time (ACT 002).

The control ASIC 14 totalizes the acquired light amount correction data of the LED devices and calculates a total value. The control ASIC 14 compares the total value and the checksum value to perform collation (verification) concerning whether the obtained light amount correction data is the same as the value stored in the EEPROM 16Y, i.e., whether the light amount correction data is regular data (ACT 003). If a collation result is satisfactory (ACT 004, OK), the operation normally ends (ACT 005). When the operation normally ends, the obtained value of the light amount correction data is transmitted to the print head 15Y again and set in a predetermined storage area of the print head 15Y. Thereafter, the print head 15Y performs correction of an output light amount on the basis of the set value.

On the other hand, if the collation result is defective (ACT 004, NG), subsequently, the control ASIC 14 increments a number-of-times-of-defectiveness counter for yellow by one and determines whether this count value (number of times of verification) reaches a predetermined number (in this example, three times) (ACT 006).

If the count value does not reach the predetermined value (ACT 006, “<N times”), the control ASIC 14 returns to the processing in ACT 001. If the count value reaches the predetermined value (ACT 006, “≧times”), the control ASIC 14 transitions to processing in ACT 500.

The control ASIC 14 performs the processing in ACT 001 to ACT 006 for each of the colors of Y, M, C, and K (for each of CH1 to CH4) (see ACT 101 to ACT 106 as well). If the number of times of defectiveness reaches the predetermined value in at least one of the channels, the control ASIC 14 performs error end processing (ACT 500). In this example, the control ASIC 14 outputs identification information of the channel, in which the error occurs, and the number of times of the error to a host system (e.g., a unit including a CPU (Central Processing Unit)). A message to the effect that the collation error occurs, the identification information of the channel (information concerning any one of the colors), and the number of times of the error are displayed on the control panel 23. The identification information (a channel number and a name of the color) of the channel and the number of times of the error displayed on the control panel 23 are useful for maintenance work by a maintenance person.

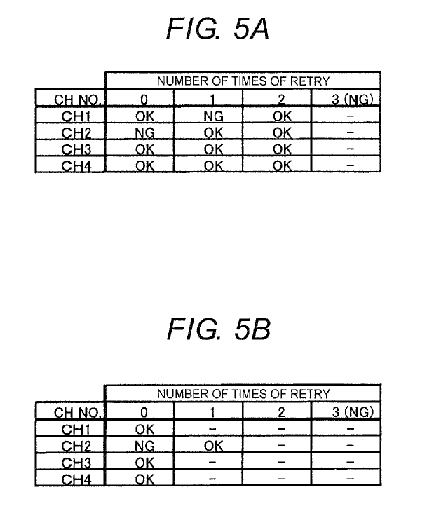

FIG. 5A is a diagram for explaining an example of the number of times of retry performed when this embodiment is not applied. FIG. 5B is a diagram for explaining an example of the number of times of retry performed when this embodiment is applied. As shown in FIG. 5A, when this embodiment is not applied, unless all checksums for the four channels (colors) match, the retry operation for all the channels is performed. On the other hand, when this embodiment is applied, as shown in FIG. 5B, the retry operation in one channel (color) units is performed.

For example, if an error occurs in the checksum collation only for CH 2 (magenta) in a first readout check, the retry operation for all the channels is performed when this embodiment is not applied (see FIG. 5A). Even if the CH2 matches after the retry, it is likely that an error occurs in another channel (in this example, CH1). Then, the retry operation is performed for all the channels again.

When this embodiment is applied, the retry operation is performed for only the channel (in this example, only the CH2) in which the error occurs. Therefore, an error does not occur in another channel during the retry. Since the retry operation for a normal channel is not performed, an unnecessary operation is not performed and power consumption can be suppressed. By adopting such a configuration, it is possible to reduce power consumption and an unnecessary communication error risk.

The control ASIC 14 transmits, for each one job, (identification information of) the channels and data of the number of times of retry shown in FIG. 5B to the host system in association with each other. The host system totalizes this data to create statistical information for making it possible to learn to which degree image quality is deteriorated. On the basis of the statistical information, a connecting section (a harness) can be examined and adjusted concerning the print head having a large number of times of retry.

When the error occurs, if printing is performed without correcting the error, streaks occur in an output image (an image formed on a sheet). However, depending on a type of the output image, the streaks can be allowed. Therefore, even when the error occurs, the job may be executed to form an image on the sheet without correcting the error. That is, when the error occurs, the error is notified to the control panel 23 but is neglected in image formation processing. It may be controlled and switched according to setting by the user whether an image is formed without correcting the error or the job is stopped.

As a data collating method, there are various forms other than a method of using the checksums. In the above explanation, the control ASIC 14 is explained as an example of the processor. The dedicated IC by the ASIC is used for data collation and the like. However, a processor such as a CPU, a main storage device such as a RAM, and a secondary storage memory such as a hard disk drive or a flash memory may be used. In this case, the processor loads a computer program stored in the secondary storage device to the main storage device and executes an arithmetic operation, whereby the data collation and the like are realized. The determination processing in ACT 004, ACT 006, and the like may be software processing performed using a computer program. As the print heads 15Y to 15K, EEPROMs 16Y to 16K, and the harnesses 17, conventional ones may be directly used.

In the above explanation, when an error occurs, the occurrence of the error is displayed on the control panel 23 and notified to the user. However, the occurrence of the error may be notified by, for example, sound such as beep sound or an E mail. The notifying unit in this case includes a speaker, a network card, or the like.

The light emitting devices are explained as the LED devices. However, a form of the light emitting devices is not limited to this. The light emitting devices may be organic EL devices or the like.

As explained above, according to the forms of this embodiment, it is possible to suppress power consumption and reduce an error risk.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a plurality of print heads, each including a plurality of light emitting devices and a storing unit configured to store light amount correction data of each of the plurality of light emitting devices; and
a processor configured to acquire each of the light amount correction data stored in the storing units of the plurality of print heads, verify whether each of the acquired light amount correction data is regular data, and, if the light amount correction data is regular data, output the regular data to the print head at an acquisition source and, if the light amount correction data is irregular data, acquire the light amount correction data from the print head at the acquisition source of the irregular data again and perform the verification concerning the light amount correction data.

2. The apparatus according to claim 1, wherein the processor performs the verification and the re-verification for each of the plurality of print heads and, if a number of times of verification reaches a predetermined number of times in one or more of the plurality of print heads, outputs identification information of the print head.

3. The apparatus according to claim 2, further comprising a notifying unit configured to notify identification information of the print head in which the number of times of verification reaches the predetermined number of times.

4. The apparatus according to claim 3, wherein the processor further outputs identification information of the plurality of print heads and numbers of times of verification of the print heads in association with each other.

5. The apparatus according to claim 4, wherein, when the number of times of verification reaches the predetermined number of times in one or more of the plurality of print heads, the apparatus executes a job currently being executed.
